(19) United States
(12) Patent Application Publication
(10) Pub. No.: US 2022/0275773 A1
(43) Pub. Date: Sep. 1, 2022

(54) AIRCRAFT HAVING A DUCTED FAN ENGINE OR AN ARRAY THEREOF

(71) Applicant: Lilium eAircraft GmbH, Wessling (DE)

(72) Inventors: Deepesh SINGH, Gilching (DE); Xabier Ochoa, Munich (DE); Weam Elsahhar, Wessling (DE); Sébastien Vermeiren, Munich (DE)

(73) Assignee: Lilium eAircraft GmbH, Wessling (DE)

(21) Appl. No.: 17/681,067

(22) Filed: Feb. 25, 2022

Related U.S. Application Data
(63) Continuation of application No. PCT/EP2022/051730, filed on Jan. 29, 2022.

(30) Foreign Application Priority Data
Feb. 26, 2021 (EP) 21159640.8

(51) Int. Cl. F02K 3/00; B64C 29/00; B64D 27/02

(52) U.S. Cl. CPC F02K 3/00; B64C 29/0033; B64D 27/02

(57) ABSTRACT

Embodiments of the disclosure are directed to a ducted fan engine configured for providing thrust for an aircraft, in particular an aircraft having vertical take-off and landing capability. The ducted fan engine includes a shroud, a stator, and a rotor rotatably supported by the shroud. The shroud has a substantially circular cross-section. The stator has at least one substantially radially-extending stator vane. The rotor comprises at least 19 rotor blades, in particular at least 25 rotor blades.

### CROSS-REFERENCE TO RELATED APPLICATIONS

This application claims priority from and benefit of European Patent Application No. EP21159640.8, titled “Ducted Fan Engine, Array of Ducted Fan Engines, and Aircraft,” and filed on Feb. 26, 2021, and PCT International Patent Application No. PCT/EP2022/051730, titled “Ducted Fan Engine, Array of Ducted Fan Engines, and Aircraft” and filed on Jan. 26, 2022, each of which is hereby incorporated by reference herein in its entirety.

### FIELD OF THE INVENTION

The present invention relates generally to aircrafts, and more specifically, to a ducted fan engine for providing thrust to propel an aircraft and to an array comprising several ducted fan engines. Furthermore, the invention relates to an aircraft, in particular an aircraft capable of vertical take-off and landing (VTOL), comprising such a ducted fan engine or array.

### BACKGROUND OF THE INVENTION

Aircraft capable of vertical take-off and landing (VTOL) have the potential to incorporate both the advantages of helicopters, namely starting and landing using limited space and/or in rough terrain, as well as the advantages of conventional aircraft, such as high traveling velocities and cruising efficiently, with one another. Challenges in the design of VTOL aircraft include the necessity that, on the one hand, large propeller areas are required for the provision of a sufficient mass flow to create thrust into the vertical direction for take-off or landing, and at the same time limit the energy consumption. On the other hand, propellers must be configured for the least amount of aerodynamic resistance for cruising, when the lift is dynamically created by means of suitable wing profiles.

Passenger aircraft capable of vertical take-off and landing are particularly suitable for use as an urban air taxi to provide regional mobility connecting city centers. In order to optimize operational feasibility, especially for a passenger oriented hop-on/hop-off service, it is desirable to maximize the total number of flights that an aircraft can make through a given airport within a given period of time, such as one day. Regulations such as EASA's 21J SC-VTOL (2019) effectively limit the number of permissible flights through a given airport by limiting the integrated noise emission in the given time of operation. Flight regulations additionally define certain safety requirements to be met, such as ingestion capability or resiliency against foreign object damage, for instance with regard to bird strike, hail strike, or the like.

General acceptance of urban air taxis is also expected to be dependent on low noise emission, with regard to both for passengers as well as for the public in the proximity of an urban airport and along travelling routes. Particularly quiet engines and aircraft are therefore desired.

### SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a ducted fan engine for providing thrust to an aircraft, in particular an aircraft having vertical take-off and landing capability, is disclosed. The ducted fan engine includes a shroud, a stator, and a rotor rotatably supported by the shroud. The shroud has a substantially circular cross-section. The stator has at least one substantially radially-extending stator vane. The rotor comprises at least 19 rotor blades, in particular at least 25 rotor blades.

According to certain aspects of the present disclosure, the rotor comprises at least 28 rotor blades, in particular at least 30 rotor blades, and/or no more than 38 rotor blades, in particular no more than 35 rotor blades.

According to certain aspects of the present disclosure, (i) the rotor includes a hub coaxial with regard to a rotary axis of the ducted fan engine, (ii) the rotor blades extend radially outward from the hub, (iii) an airfoil of the rotor blades extends approximately parallel to the rotary axis in the proximity of the rotor hub, and/or (iv) the airfoil of the rotor blades extends at an inclination of approximately at least about 20°, in particular at least about 35°, and/or no more than about 60°, in particular no more than about 45°, with respect to the rotary axis at an end of the rotor blades distal with regard to the rotor hub.

According to certain aspects of the present disclosure, the rotor blades have a rear edge extending essentially straight in the radial direction, in particular perpendicular to the rotary axis, and/or wherein the rotor blades have a concave leading edge.

According to certain aspects of the present disclosure, the stator comprises no more than 12 stator vanes, in particular no more than 8 stator vanes, more particularly no more than 8 stator vanes, and/or at least 2 stator vanes, in particular 4 stator vanes.

According to certain aspects of the present disclosure, (i) the at least one stator vane extends radially between the inner surface of the shroud and the outer surface of a stator housing, (ii) an airfoil of the at least one stator vane is essentially constant in a radial direction, and/or (iii) the airfoil of the at least one stator vane extends at an inclination of approximately at least about −5°, in particular at least about −10°, and/or no more than about −30°, in particular no more than about −20°, with respect to the rotary axis.

According to certain aspects of the present disclosure, the ratio of stator vanes to rotor blades is at least about 1/20, in particular at least about 1/10, and/or no more than about 1/2, in particular no more than about 2/7, in particular no more than about 1/5, more particularly no more than about 1/6, wherein most particularly, the ratio lies between about 1/8 and about 1/9.

According to certain aspects of the present disclosure, an axial length (a_{V}) of the at least one stator vane is larger than the axial length of the rotor blades, wherein in particular the at least one stator vane is at least about twice as long, in particular at least about 4 times as long, more particularly at least about 5 times, as long as the rotor blades, and/or no more than about 10 times, in particular no more than about 8 times, more particularly no more than about 6 times as long as the rotor blades.

According to certain aspects of the present disclosure, the width (d), in particular inner diameter, of the shroud is no larger than about 500 mm, in particular in a range of about 200 mm to about 400 mm, more particularly in a range of about 270 mm to about 330 mm.

According to certain aspects of the present disclosure, the ducted fan engine comprises at least one electromotor configured for driving the rotor.

According to certain aspects of the present disclosure, an array includes more than one, in particular two, three or five, ducted fan engines, wherein the ducted fan engines are rigidly coupled to one another, in particular in an axis-parallel manner.

According to certain aspects of the present disclosure, an aircraft, in particular a passenger aircraft, having vertical take-off and landing capability includes a fuselage and an array of ducted fan engines, wherein the array is pivotably connected to the fuselage around a pitch axis of the aircraft.

According to certain aspects of the present disclosure, the aircraft further has a cruise flight state in which the more than one ducted fan engine is oriented with its rotary axis corresponding to a longitudinal axis of the aircraft at an altitude of about 20 meters, and in which noise emission determined in a lateral distance of about 100 meters lies below about 65 dBA, in particular below about 62 dBA, more particularly below about 60 dBA, most particularly below about 55 dBA.

According to certain aspects of the present disclosure, the aircraft further has an approach and/or transition state in which the more than one ducted fan engine is tilted with its rotary axis oriented between the longitudinal axis and the yaw axis of the aircraft at an altitude of at least about 4 meters and in which noise emission determined in a distance of about 100 meters lies below about 73 dBA, in particular below about 70 dBA, more particularly below about 68 dBA, most particularly below about 65 dBA or below about 60 dBA.

According to certain aspects of the present disclosure, the aircraft further has a hovering state in which the more than one ducted fan engine is oriented with its rotary axis corresponding to a yaw axis of the aircraft at an altitude of about 4 meters in which noise emission determined in a distance of about 100 meters lies below about 70 dBA, in particular below about 68 dBA, more particularly below about 65 dBA, most particularly below about 63 dBA or below about 60 dBA.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

Preferred configurations of the invention are described in the dependent claims. The accompanying drawings illustrate the embodiments of the present disclosure and, together with the description, further serve to explain the principles of the embodiments and to enable a person skilled in the pertinent art to make and use the embodiments.

FIG. 1 is a perspective view of an aircraft according to the invention comprising a variable lift body arranged in a tilted position, according to certain aspects of the present disclosure.

FIG. 2 is a schematic view of the variable lift body according to FIG. 1, according to certain aspects of the present disclosure.

FIG. 3 is a schematic front view of a ducted fan engine, according to certain aspects of the present disclosure.

FIG. 4 is a schematic perspective view of the rotor and stator of the ducted fan engine according to FIG. 3, according to certain aspects of the present disclosure.

FIG. 5 is a schematic cross sectional side view of a ducted fan engine, according to certain aspects of the present disclosure.

FIG. 6a is an experimental setup for measuring sound emissions in hover flight state, according to certain aspects of the present disclosure.

FIG. 6b is an experimental setup for measuring sound emissions in cruise flight state, according to certain aspects of the present disclosure.

The present disclosure is susceptible to various modifications and alternative forms, and some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

An electric VTOL (eVTOL) aircraft with multiple electrically-powered ducted fan engines, each of which comprise a shroud containing a stator with at least one stator vane or guiding vane and a rotor with several rotor blades, is known in the art. Known VTOL aircraft using ducted fan engines, such as the Bell X-22 or the Doak VZ-4 have four or eight rotor blades, respectively, and a corresponding number of stator vanes.

Vertical take-off aircraft designed for hovering flight comprise engines that can be rotated about a pivot axis. During take-off, landing, or hovering flight, the engines are placed in a take-off/landing position in which the direction of thrust is oriented vertically. In order to accelerate the aircraft after take-off, the engines may be continuously pivoted in such a way that the direction of thrust is ultimately aligned with a cruise flight direction. The thrust provided by the engine to power the aircraft is transferred towards the fuselage through a mechanical system attaching the engine to the fuselage and allowing the engine to be pivoted in relation to the fuselage.

It is an object of the invention to overcome the disadvantages of the prior art, in particular to provide a quiet and/or energy efficient engine for propelling an aircraft and aircraft, particularly a VTOL, more particularly an eVTOL. This objective is solved by the subject matter of independent claim 1.

Accordingly, a ducted fan engine is configured for providing thrust for an aircraft, in particular an aircraft having vertical take-off and landing capability, such as an eVTOL aircraft. The ducted fan engine comprises a shroud having a substantially circular cross-section. The shroud may alternatively be called duct. The shroud realizes casing in which a rotor and stator are arranged and through which an airflow may be conveyed for propelling the aircraft. The shroud of the ducted fan engine may include an aerodynamic control structure, such as a control canard, a canard structure, an aileron or landing flap.

In the ducted fan engine, the rotor imparts momentum onto the incoming air flow increasing its pressure, temperature and radial swirling, corresponding to the simultaneously generated thrust. Ducted fan engines have the inherent capability to reduce noise radiated by an aircraft to the environment by shielding noise sources through the shroud of the engine, thereby reducing emission angles.

The ducted fan engine further comprises a stator comprising one or more substantially radially extending stator vanes, and a rotor rotatably supported by the shroud. The stator may include a shaft arranged at a radially inner region of the stator to which shaft the rotor is attached. The ducted fan engine defines a rotary axis around which the rotor rotates. It may be preferred that the shroud, the stator and the rotor share a common coaxial orientation with regard to the rotary axis. It may be preferred that the ducted fan engine comprises no more than one rotor and/or no more than one stator. The arrangement of the stator, preferably behind the rotor with regard to the forward direction of the aircraft, allows to provide one or more stator-vanes for de-swirling angular flow caused by the rotor, and to recover parallel velocity of the air conveyed through the shroud thus helping to gain more thrust and aerodynamic engine efficiency.

According to the invention, the rotor comprises at least 19 rotor blades, in particular at least 25 rotor blades. Several rotor blades may be arranged on the outside of a rotor hub in rotationally symmetrical manner and/or in equal circumferential distances to one another. In particular, the number of rotor blades is larger than the number of stator vanes or guide vanes of the ducted fan engine. For example, the number of stator vanes may be less than half, in particular less than one third, of the number of rotor blades. Surprisingly, it was shown that fan tones are caused by the ducted fan engine are to a large extent caused by the interaction of incoming turbulence with the fan, wherein a higher rotor blade count was shown to be helpful to chop off any incoming turbulence thereby reducing fan tones. Airflow entering the shroud of the ducted fan engine is in many instances not uniform due to, for example, atmospheric wind instabilities. Those instabilities are ingested by the fan and interact with the leading edge of the rotor, for example whenever a rotor blade interacts with an instability or vortex. During the course of one second, an instability or vortex may cause a multitude of such interactions dependent on the RPM and the rotor blade number of the engine, causing rotor tones and/or, in case of non-periodic interactions, broadband noise emitted throughout a multitude of different frequencies. A combination of rotor tones and rotor broadband noise may be referred to as rotor noise. Rotor noise travels mostly upstream. The downstream propagation of rotor noise may be reduced by the at least one stator vane. The selection of an unusually high number of 19, 25 or more, for example 30, 40, or more, rotor blades for a ducted fan engine has surprisingly shown to significantly reduce fan tones, thereby rendering an aircraft using one or more ducted fan engines according to the invention significantly quieter than aircraft using other engines.

According to a further development, the rotor comprises at least 28 rotor blades, in particular at least 30 rotor blades. Alternatively or additionally, the rotor comprises no more than 45 rotor blades or no more than 38 rotor blades, in particular no more than 35 rotor blades. It may be preferred that the ducted fan engines rotor comprises exactly 33 rotor blades. Although increasing the number of rotor blades leads to less sound emission, the ducted fan engine's ingestion capability and/or manufacturing costs were shown to be affected detrimentally for an exceedingly large rotor blade count.

In one embodiment of a ducted fan engine, the rotor includes a hub coaxial with regard to a rotary axis of the ducted fan engine, wherein the rotor blades extend radially outward from the hub. The airfoil of the rotor blades extends approximately parallel to the rotary axis in the proximity of the rotor hub. Alternatively or additionally, the airfoil of the rotor blades extends at an inclination of approximately at least 20° and/or no more than 60° with respect to the rotary axis at an end of the rotor blades distal with regard to the rotor hub. The airfoil of the rotor blades may at their respective distal end have an inclination of approximately at least 35° and/or no more than 45°, in particular approximately 40°, with respect to the rotary axis. In the radial extension of a rotor blade, the inclination of its airfoil may increase continuously towards the outside. Such a rotor blade design was shown to be advantageous with regard to thrust efficiency as well as noise reduction.

In another embodiment of a ducted fan engine, which may be combined with the above-mentioned ones, the rotor blades have a rear edge (or trailing edge) extending essentially straight in the radial direction, in particular perpendicular to the rotary axis, particularly with a slight concave curvature. Additionally or alternatively, the rotor blades have a leading edge (or forward edge) extending in the radial direction having a concave shape. Such rotor blade design was shown to be advantageous with regard to thrust efficiency as well as noise reduction.

According to one embodiment of the ducted fan engine, which may be combined with the aforementioned ones, the stator comprises no more than 12 stator vanes. In particular, the stator comprises no more than ten or eight stator vanes, more particularly no more than six stator vanes. Additionally or alternatively, the stator comprises at least two or three stator vanes. It may be preferred that the stator comprises exactly 4 stator vanes. Defining a minimal number of stator vanes larger than one has been shown to improve aerodynamic efficiency of the engine. Several stator vanes may be arranged on the outside of the stator housing in rotationally symmetrical manner and/or in equal circumferential distances to one another. The at least one stator vane or guide vane serves to realign airstream in the direction of the rotary axis of the ducted fan engine after the airstream was imposed with swirl by the rotor, thereby recovering parallel airflow velocity so as to gain more thrust and aerodynamic engine efficiency. However, the impact of the airstream coming from the rotor onto the at least one stator vane leads to periodic interaction of the rotor wakes with the leading edge of the stator vane downstream of the rotor, causing blade passing frequency tones which are also called interaction tones. Any non-periodic interaction of the stator vanes with remnants of vortices or instabilities having passed the rotor leads to further broadband noise. The interaction tones and interaction broadband noise may be referred to as interaction noise. Such interaction noise is mostly present downstream of the ducted fan engine whereas upstream propagation is reduced by the rotor. By decreasing vane number, the number of instances in which rotor wakes strike the stator vane causing interaction noise was shown to be decreased.

In one embodiment of a ducted fan engine, which may be combined with the aforementioned ones, the at least one stator vane extends radially between an inner surface of the shroud and an outer surface of a stator housing. The stator housing is rigidly attached to the shroud through the at least one stator vane. The airfoil of the at least one stator vane is essentially constant in the radial direction. Alternatively or additionally, the airfoil of the at least one stator vane extends at an inclination of approximately at least −5° and/or no more than −30° with respect to the rotary axis. In particular, the inclination of the airfoil in the stator vanes may be at least −10° and/or no more than −20°. It may be preferred that, in case of the rotor blades having an inclination, the stator vanes have an inclination oriented towards the opposite side with regard to the rotary axis, such that swirl imparted onto the airflow by the rotor may be de-swirled by a corresponding, opposite inclination of the stator. Such stator van design was shown to be advantageous with regard to thrust efficiency as well as noise reduction.

According to an embodiment of the ducted fan engine that may be combined with the above-mentioned ones, the ratio of the number of stator vanes to the number of rotor blades is at least 1/20, in particular at least 1/10, and/or no more than 2/7, in particular no more than 1/2 or no more than 1/5, more particularly no more than 1/6. Most particularly, the ratio may lie between 1/8 and 1/9. A preferred ratio may be 4/33. Such ratios of number of stator vanes with respect to number of rotor blades have been shown to yield particularly desirable results with regard to sound emission and engine efficiency.

In another embodiment of a ducted fan engine, which may be combined with the aforementioned ones, the axial length of the at least one stator vane is larger than the axial length of the rotor blades. The axial length of a rotor blade or stator vane, respectively, shall be determined as the length in the direction of the rotary axis of the ducted fan engine, in particular on the respective radial inner end of the stator vane or rotor blade, that is in the radial proximity of the rotor hub or stator housing. In particular, the at least one stator vane is at least twice as long, in particular at least four times as long, more particularly at least five times as long, as the rotor blades. Additionally or alternatively, the at least one stator vane is no more than 10 times, in particular no more than eight times, more particularly no more than six times, as large as the rotor blades. It has been shown that using a relatively larger stator vane in comparison to the rotor blades helps to improve engine efficiency through de-swirling the airflow while allowing to minimize the number of stator vanes so as to avoid interaction noise.

A ducted fan engine according to a further embodiment, which may be combined with the aforementioned ones, has a shroud with a width, in particular an inner diameter, being no larger than 500 mm, in particular in a range of 200 mm to 400 mm, more particularly in a range of 270 mm to 330 mm. In a preferred embodiment, the inner diameter of a shroud may be 300 mm. The inner diameter of the shroud is larger than the outer diameter of the rotor, allowing the rotor to be housed and rotate within the shroud. In order to optimize the use of the shroud surrounding the rotor, however, it may be preferred that the outer (distal) diameter of the rotor blades is at least 70%, in particular at least 80%, more particularly at least 90% or 95% of the inner diameter of the shroud. Surprisingly, it was shown that ducted fan engines of a small shroud diameter are particularly suitable to maximize both engine efficiency as well as noise reduction.

According to one embodiment of the ducted fan engine, it comprises at least one electromotor configured for driving the rotor. It may be preferred that the electromotor is encased within the stator housing and/or within the rotor hub. The at least one electromotor may have an output shaft directly coupled to the rotor or may be provided with a transmission coupling an output shaft of the electromotor to the rotor. Electromotors can be operated at significantly lower noise emission levels than combustion engines. The arrangement of an electromotor in the proximity of the rotor allows to minimize drag impact of the motor onto the aircraft, thus allowing for increased overall aircraft operation efficiency.

The invention also relates to an array of several ducted fan engines rigidly coupled to one another, in particular in an axis-parallel manner. It may be preferred that two, three or five ducted fan engines are rigidly coupled to one another, in particular with their respective rotary axes parallel to one another. Using arrays of ducted fan engines such as described above allows for a distribution of sound emission sources at the aircraft, thereby reducing noise radiation.

Another aspect of the invention relates to an aircraft, in particular a passenger aircraft, having vertical take-off and landing capability, in particular an electronically powered vertical take-off and landing aircraft (eVTOL), including a fuselage and at least one ducted fan engine, or an array of more than one ducted fan engines as described above. The aircraft may be equipped with at least 10 or at least 20, in particular at least 30, and/or no more than 100 or no more than 50, in particular no more than 40 ducted fan engines. A preferred aircraft may comprise 36 ducted fan engines. The at least one ducted fan engine or at least one array of ducted fan engines is rotatably connected to the fuselage around a pitch axis of the aircraft. The aircraft in particular includes an engine pivotable in relation to the fuselage between a cruising flight position in which the thrust direction of the engine is aligned with the longitudinal axis of the aircraft, and a take-off and landing position in which the thrust direction of the engine is angled towards the vertical axis of the aircraft. Engines being pivotably attached to the fuselage of the aircraft may be described as a thrust vectoring system. The aircraft can include at least one pivotable ducted fan engine in the rear of the aircraft, in particular in combination with an aileron. Particularly, the aircraft may be provided with several, in particular exactly 2, exactly 3, or exactly 4, trailing pairs of arrays of the ducted fan engines arranged in the rear of the aircraft. Alternatively or additionally, the aircraft can include at least one ducted fan engine in the front of the aircraft, in particular in the manner of, instead of, or in combination with a canard. Particularly, the aircraft may be provided with one or more, in particular exactly 1, or exactly 2, leading pairs of arrays of ducted fan engines arranged in the front of the aircraft. Alternatively or additionally, the aircraft can include at least one ducted fan engine attached to a central section of the aircraft with regard to its lengthwise extension, in particular in combination with a lift body such as a wing, winglet or canard. The aircraft can include a plurality of engines arranged side-by-side in a row transversely to the direction of flow and/or in the direction of the pitch axis. By providing an aircraft with a ducted fan engine such as described above, the overall noise emission of the aircraft can be minimized.

According to a further development, the aircraft has a cruise flight state in which the at least one ducted fan engine is oriented with its rotary axis corresponding to a longitudinal axis of the aircraft at an altitude of approximately 20 m and in which noise emission determined in a lateral distance of 100 m lies below 65 dBA, in particular below 62 dBA, more particularly below 60 dBA, most particularly below 55 dBA. Advantageously, the aircraft using one or more ducted fan engines as described above is inaudible from the ground when flying above 400 m.

In one embodiment of an aircraft, which may be combined with the aforementioned one, the aircraft has an approach and/or transition state in which the at least one ducted fan engine is tilted with its rotary axis oriented between the longitudinal axis and the yaw axis of the aircraft at an altitude of approximately 4 m or more and in which noise emission determined in distance of 100 m lies below 73 dBA, in particular below 70 dBA, more particularly below 68 dBA, most particularly below 65 dBA or below 60 dBA. Thereby, the aircraft using one or more ducted fan engines as described above is no louder while taking off than a passing truck.

In one embodiment of an aircraft, which may be combined with the aforementioned one, the aircraft has a hovering state in which the at least one ducted fan engine is oriented with its rotary axis corresponding to a yaw axis of the aircraft at an altitude of approximately 4 m in which noise emission determined in distance of 100 m lies below 70 dBA, in particular below 68 dBA, more particularly below 65 dBA, most particularly below 63 dBA or below 60 dBA.

The aircraft may include at least one primary lift body, such as a canard structure and/or a wing, which is stationarily attached to the fuselage, wherein the at least one ducted fan engine or array of ducted fan engines is attached to the primary lift body. The primary lift body may have a relatively large surface area extending in the wing span direction and the longitudinal direction of the aircraft. The primary lift body may be a statically loadbearing element for providing a lifting force during cruising flight of the aircraft in the primary cruise flight direction. It may be preferred that the primary lift body is integrally connected to the fuselage of the aircraft. In particular, the at least one ducted fan engine is arranged behind the primary lift body with regard to the cruise flight direction of the aircraft.

In particular, the aircraft is configured to be manned with at least two, preferably at least four, more preferred exactly five passengers, who may include at least one aircraft pilot. The passenger aircraft comprises a cabin for carrying one or more human passengers. In particular, the cabin for the passengers is located in the forward portion of the aircraft. The use of the ducted fan engine described herein allows to reduce or completely omit the necessity for sound absorption components which may usually surround an aircraft passenger cabin without impairing passenger comfort, rendering the aircraft lighter and thus overall more efficient.

Referring to the figures, reference numeral 100 generally designates an aircraft provided with two sets of ducted fan engines 1 arranged into a respective array 10. The aircraft 100 comprises a fuselage 103 with wings 105 attached thereto. Each wing 105 carries a respective array 10 of ducted fan engines 1. It is conceivable that each wing 105 carries two or more respective arrays of ducted fan engines 1 and/or one or more ducted fan engine 1 mounted individually pivotable to the wing 105 and/or fuselage 103. In the illustrated embodiment, the aileron 107 with the ducted fan engine 1 is rotatably attached to the fuselage 103 via the wing 105. In relation to the fuselage 103, the ducted fan engine 1 is pivotable around the lateral or pitch axis Y corresponding to the direction of the wing span.

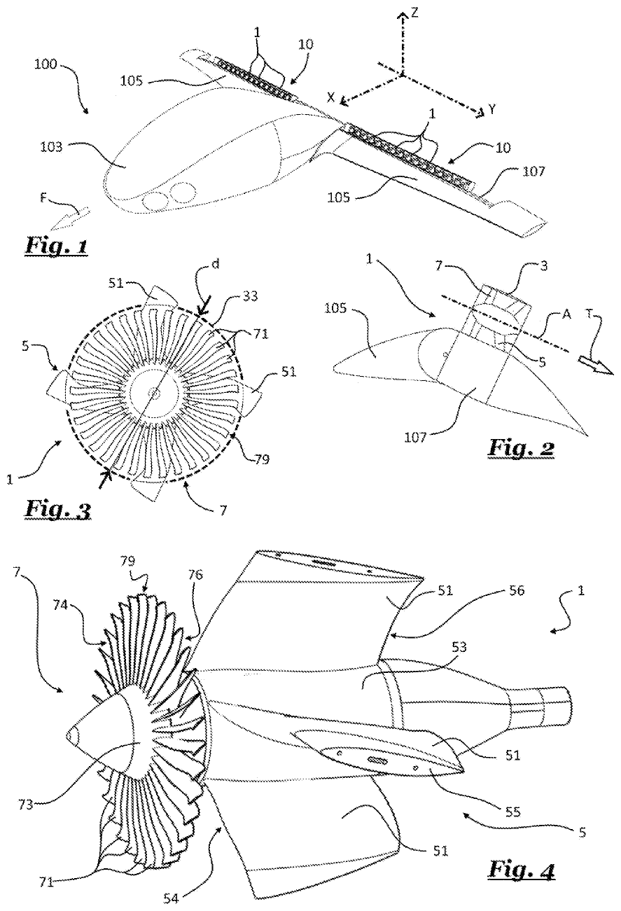

FIG. 1 shows the aircraft 100 having the array 10 arranged in a tilted position in relation to the fuselage 103. FIG. 1 shows the an aileron 107 including the ducted fan engine array 10 comprising a multitude of electrically-powered ducted fan engines 1 arranged in a tilted intermediate pivoting position which may correspond to a state after take-off and before cruise flight or after cruise flight and before landing, which is shown in further detail in FIG. 2. It shall be clear that the ducted fan engines 1 could be in a different position, such as a cruise flight position in which the axis A of the engines is arranged corresponding, in particular essentially parallel or parallel, to the longitudinal or roll axis X (not shown). In the a cruising position, the direction of thrust T of the ducted fan engine 1 is aligned with the forward cruise flight direction F. The forward cruise flight direction F may correspond to the longitudinal axis or roll axis X of the aircraft 100. Alternatively, it shall be clear that the ducted fan engines 1 could be arranged in yet another position, such as a vertical take-off and/or landing or hovering position in which the axis A of the engines is arranged corresponding, in particular essentially parallel or parallel, to the vertical or yaw axis Z (not shown).

FIG. 2 shows the aileron 107 with a ducted fan engine 1 in a tilted intermediate pivoting position which may correspond to a state after take-off and before cruise flight or after cruise flight and before landing. The multitude of electrically-powered ducted fan engines 1 are arranged immediately adjacent one another in the direction of the pitch axis Y of the aircraft 100. In the exemplary embodiment of a passenger aircraft 100 including a cabin shown in FIG. 1, one pair of arrays 10 of multiple individual ducted fan engines 1 is attached to the rear of the left and right wing 105. Alternatively, several pairs of arrays 10 could be attached to the wings 105, for example two, three or four pairs of arrays 10, wherein each array may be pivotable with regard to the fuselage 103 independent of the other. At least one pair of ducted fan engines 1 or at least pair of arrays 10 of ducted fan engines may alternatively or additionally be attached to the front of the aircraft 100, optionally as or in combination with a canard structure (not shown).

FIG. 3 shows a schematic front view onto a ducted fan engine 1. The inner diameter d defined by an inner surface 33 of the shroud 3 of the ducted fan engine 1 is indicated as a dashed line surrounding the rotor blades 71 of the rotor 7. Several stator vanes 51 of a stator 5 attaching the rotor 7 to the shroud 3 are visible behind the rotor blades 71. The outer diameter of the rotor 7 defined by the distal ends 79 of the rotor blades 71 is almost as large as the inner diameter d of the shroud 3. In the exemplary embodiment of a ducted fan engine 1, the single rotor 7 includes 33 rotor blades, which may all be of the same design.

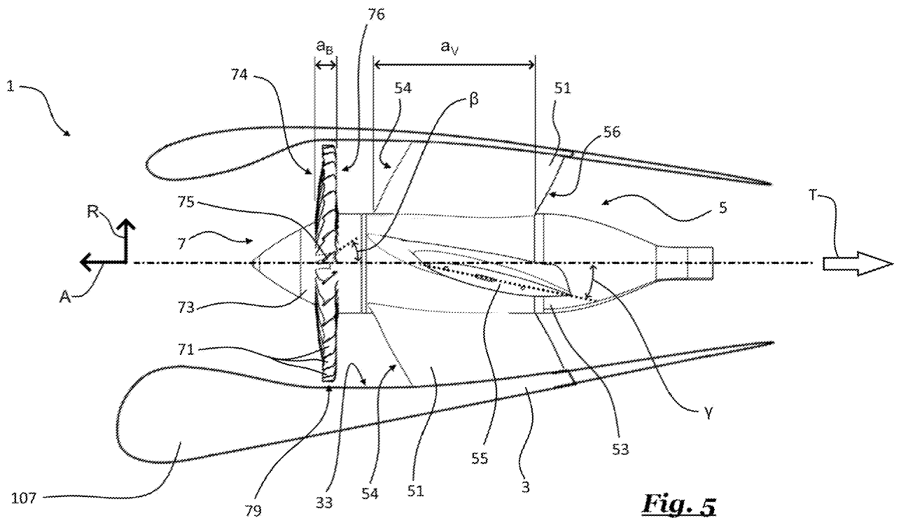

FIG. 4 shows a schematic perspective view of the stator 5 and rotor 7 of the ducted fan engine 1. The shroud 3 is not shown in FIG. 4 so that the other components are clearly visible. The stator 5 shown in the exemplary embodiment comprises 4 large stator vanes 51 which may alternatively be called guiding vanes or stator blades. The stator vanes 51 extend in a generally radial direction R from a stator housing 53 towards the shroud 3. The stator housing 53 may be of generally cylindrical design and contain at least one electromotor and/or transmission for driving the rotor 7 therein. The stator vanes 51 may all be of the same design. The stator vanes 51 each define a respective airfoil 55. The airfoil 55 of each stator vane 51 may be essentially constant along the radial extension of the stator vane 51. The stator vane 51 may have a leading edge 54 and the trailing edge 56 both of which may be inclined with respect to the radial direction R at an angle between 20° and 45°, in particular approximately 30°, so as to minimize interaction noise. The stator vanes 51 attach the stator housing 53 and the rotor 7 rotatably mounted thereto to the shroud 3. The stator vanes 51 define an airfoil 55 with a continuous inclination γ of for example approximately 15° with regard to the rotary axis A.

FIG. 5 shows a schematic sectional side view of a ducted fan engine 1 with a shroud 3 integrally formed with an aileron 107. The ducted fan engine 1 defines a rotary axis A in regard to which the shroud 3, stator 5, and rotor 7 are arranged coaxially. With regard to an airflow streaming through the ducted fan engine 1 for propelling the aircraft, the rotor 7 is arranged upstream of the stator 5. The shroud 3 defines an approximately cylindrical cross-section for the airflow. The diameter d of the shroud 3, in particular in the area of the rotor 7, may be less than 500 mm, in particular between 250 and 350 mm, for example 300 mm.

The rotor blades 71 define an airfoil 75 with an inclination β with regard to the rotary axis A increasing from the rotor hub 73 towards the respective radially outward distal end 79 of the rotor blade. In the proximity of the rotor hub 73, the inclination β may be at a minimum and close to 0°. At the distal end 79, the inclination β may reach a maximum of for example approximately 40°. The inclination γ of the stator vanes 51 is oriented opposite to the inclination β of the rotor blades 71 such that swirl introduced into the airflow by the rotor 7 is reduced through the stator 5.

The leading edge 74 of the rotor blade 71 may have a concave shape with regard to the axial direction A. The trailing edge 76 of the rotor blade 71 may be essentially rectilinear. The rotor blade 71 may be curved in the forward direction at the distal end 79. The rotor blades 71 are arranged equidistantly around the circumference of the rotor hub 73 and attached thereto such that the rotor hub 73 and the rotor blades 71 rotate together to accelerate the airflow through the ducted fan engine 1 so as to propel the aircraft. It may be preferred that the trailing edge 76 of the rotor blade 71 and the leading edge 54 of the stator vane 51 are oriented and/or shaped different from one another.

The axial vane length aV measured along the stator housing 53 is substantially larger than the axial blade length aB measured at the rotor hub 73. As shown in FIG. 5, axial vane length aV may be approximately five to six times as large as the axial blade length aB.

### Experiments

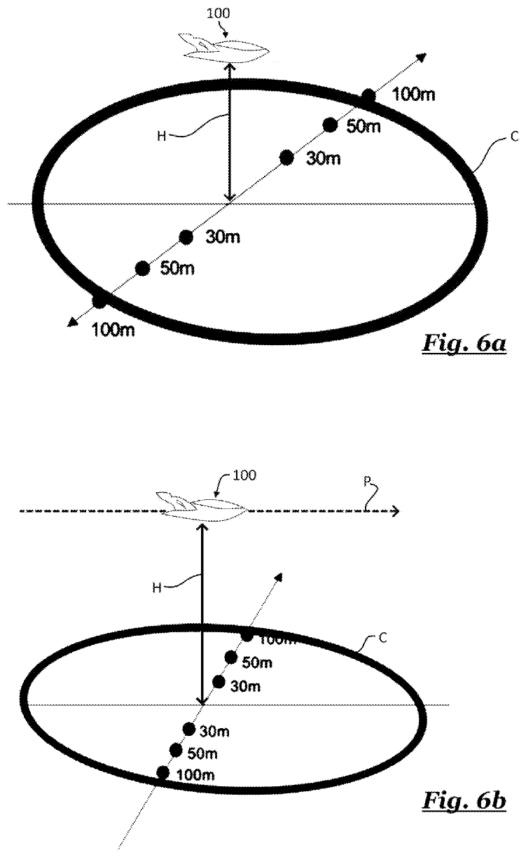

FIG. 6a shows an experimental setup for measuring noise emissions (dBA) for an aircraft 100 as described with regard to FIG. 1. In a first experiment, the aircraft 100 is operated in a hover state at an altitude H of approximately at least 4 m above a level ground. Sound emissions may be detected at one or more spots from the ground. With a microphone positioned in different spots along a circle C having a radius of 100 m centered around the aircraft 100, sound emissions between approximately 62 dBA and 68 dBA were detected. Farfield noise measured at in a distance of 100 m from the aircraft was found to be between 58 dBA and 64 dBA.

In a second experiment with the experimental setup as shown in FIG. 6a as described above, the aircraft 100 is operated in an approach/transition state. Noise is measured in a horizontal distance of 100 m from the aircraft. Sound emissions were found to be between 64 dBA and 68 dBA.

FIG. 6b shows a different experimental setup for measuring noise emissions (dBA) for an aircraft 100 as described with regard to FIG. 1. In a third experiment, the aircraft 100 is operated in a cruise flight state at an altitude H of approximately at least 20 m above a level ground, flying along a path P crossing the 200 m diameter measurement circle C diametrically. Noise is measured at in a horizontal distance of 100 m from the aircraft. Sound emissions were found to be less than 62 dBA at a lateral distance of 100 m.

Table 1 below shows engine noise levels for different engine configurations for a ducted fan engine 1 such as described above with respect to FIGS. 2-4, comprising different pairings of rotor blades and stator vanes numbers.

TABLE 1
Noise level (dBA) for different 300 mm shroud diameter
engine configurations with equal operating thrust levels
at corresponding RPM measured in an echoic free field
environment at 1 m and 90° from engine axis

| | | blades | | |
|---|---|---|---|---|
| sound emission in dBA | | 12 | 19 | 33 |
| vanes | 4 | 99 | 97 | 93 |
| | 6 | 100 | 99 | 95 |
| | 23 | 101 | 100 | 98 |

The features disclosed in the above description, in the figures and in the claims can be of importance both individually and in any combination for the realization of the invention in its various configurations.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

### REFERENCE NUMBERS

1 ducted fan engine
3 shroud
5 stator
7 rotor
10 array
33 inner surface
51 stator vane
53 stator housing
54 leading edge
55 vane airfoil
56 trailing edge
71 rotor blade
73 rotor hub
74 leading edge
75 blade airfoil
76 rear edge
79 distal end
100 aircraft
103 fuselage
105 wing
107 aileron
aB axial blade length
aV axial vane length
d diameter
A rotary axis
C circle
F cruise flight direction
H altitude
P path
T thrust direction
X roll axis; longitudinal axis
Y pitch axis; lateral axis
Z yaw axis; vertical axis
β blade inclination
γ vane inclination.

What is claimed is:

1. A ducted fan engine for providing thrust to an aircraft, in particular an aircraft having vertical take-off and landing capability, the ducted fan engine comprising:
a shroud having a substantially circular cross-section;
a stator having at least one substantially radially-extending stator vane; and
a rotor rotatably supported by the shroud, wherein the rotor comprises at least 19 rotor blades, in particular at least 25 rotor blades.

2. The ducted fan engine of claim 1, wherein the rotor comprises at least 28 rotor blades, in particular at least 30 rotor blades, and/or no more than 38 rotor blades, in particular no more than 35 rotor blades.

3. The ducted fan engine of claim 1, wherein: (i) the rotor includes a hub coaxial with regard to a rotary axis of the ducted fan engine, (ii) the rotor blades extend radially outward from the hub, (iii) an airfoil of the rotor blades extends approximately parallel to the rotary axis in proximity of the rotor hub, and/or (iv) the airfoil of the rotor blades extends at an inclination of approximately at least about 20°, in particular at least about 35°, and/or no more than about 60°, in particular no more than about 45°, with respect to the rotary axis at an end of the rotor blades distal with regard to the rotor hub.

4. The ducted fan engine of claim 3, wherein the rotor blades have a rear edge extending essentially straight in a radial direction, in particular perpendicular to the rotary axis, and/or wherein the rotor blades have a concave leading edge.

5. The ducted fan engine of claim 1, wherein the stator comprises no more than 12 stator vanes, in particular no more than 8 stator vanes, more particularly no more than 8 stator vanes, and/or at least 2 stator vanes, in particular 4 stator vanes.

6. The ducted fan engine of claim 5, wherein: (i) the at least one stator vane extends radially between an inner surface of the shroud and an outer surface of a stator housing, (ii) an airfoil of the at least one stator vane is essentially constant in a radial direction, and/or (iii) the airfoil of the at least one stator vane extends at an inclination of approximately at least about −5°, in particular at least about −10°, and/or no more than about −30°, in particular no more than about −20°, with respect to the rotary axis.

7. The ducted fan engine of claim 1, wherein a ratio of stator vanes to rotor blades is at least about 1/20, in particular at least about 1/10, and/or no more than about 1/2, in particular no more than about 2/7, in particular no more than about 1/5, more particularly no more than about 1/6, wherein most particularly, the ratio lies between about 1/8 and about 1/9.

8. The ducted fan engine of claim 1, wherein an axial length (a_{V}) of the at least one stator vane is larger than the axial length of the rotor blades, wherein in particular the at least one stator vane is at least about twice as long, in particular at least about 4 times as long, more particularly at least about 5 times, as long as the rotor blades, and/or no more than about 10 times, in particular no more than about 8 times, more particularly no more than about 6 times as long as the rotor blades.

9. The ducted fan engine of claim 1, wherein a width (d), in particular inner diameter, of the shroud is no larger than about 500 mm, in particular in a range of about 200 mm to about 400 mm, more particularly in a range of about 270 mm to about 330 mm.

10. The ducted fan engine of claim 1, wherein the ducted fan engine comprises at least one electromotor configured for driving the rotor.

11. An array of more than one, in particular two, three or five of the ducted fan engine of claim 1, wherein the ducted fan engines are rigidly coupled to one another, in particular in an axis-parallel manner.

12. An aircraft, in particular a passenger aircraft, having vertical take-off and landing capability including a fuselage and an array according to claim 11, wherein the array is pivotably connected to the fuselage around a pitch axis of the aircraft.

13. The aircraft of claim 12, further having a cruise flight state in which the more than one ducted fan engine is oriented with a rotary axis thereof corresponding to a longitudinal axis of the aircraft at an altitude of about 20 meters, and in which noise emission determined in a lateral distance of about 100 meters lies below about 65 dBA, in particular below about 62 dBA, more particularly below about 60 dBA, most particularly below about 55 dBA.

14. The aircraft of claim 12, further having an approach and/or transition state in which the more than one ducted fan engine is tilted with a rotary axis thereof oriented between a longitudinal axis and a yaw axis of the aircraft at an altitude of at least about 4 meters, and in which noise emission determined in a distance of about 100 meters lies below about 73 dBA, in particular below about 70 dBA, more particularly below about 68 dBA, most particularly below about 65 dBA or below about 60 dBA.

15. The aircraft of claim 12, further having a hovering state in which the more than one ducted fan engine is oriented with a rotary axis thereof corresponding to a yaw axis of the aircraft at an altitude of about 4 meters, and in which noise emission determined in a distance of about 100 meters lies below about 70 dBA, in particular below about 68 dBA, more particularly below about 65 dBA, most particularly below about 63 dBA or below about 60 dBA.
